(19) United States
(12) Patent Application Publication
(10) Pub. No.: US 2005/0062396 A1
(43) Pub. Date: Mar. 24, 2005

(54) Multi-hooded pixel

(76) Inventor: Heston Yang, Taipei (CA)

Correspondence Address: WANG & PATEL, P.C., 1301 DOVE STREET, SUITE 1050, NEWPORT BEACH, CA, 92660, US

(21) Appl. No.: 10/830,582

(22) Filed: Apr. 22, 2004

Related U.S. Application Data
(60) Provisional application No. 60/465,183, filed on Apr. 24, 2003.

(51) Int. Cl. F21V 19/04

(52) U.S. Cl. 313/470

(57) ABSTRACT

In one embodiment, a pixel for use in light-emitting displays is disclosed. Each pixel includes an enclosure with apertures adapted to receive light sources and hoods attached to the enclosure so as to project outwardly from the enclosure. Each aperture is adjacent to a hood. The hoods shelter the apertures from sunlight or other incoming external light. Individual light sources, such as LEDs, are fitted into the apertures. In another embodiment, a method is provided to manufacture light-emitting displays by attaching a plurality of light sources within an enclosure, then attaching a plurality of hoods to the enclosure so as to shelter the light sources from incoming external light.

### CROSS-REFERENCE TO RELATED APPLICATIONS

This application claims priority from U.S. provisional patent application Ser. No. 60/465,183, filed Apr. 24, 2003, the entire contents of which is incorporated herein by reference.

### FIELD OF THE INVENTION

The present invention relates generally to light-emitting displays, and particularly to a light-emitting display including multiple pixels, where each pixel includes an enclosure having multiple light sources and multiple hoods such that each light source is adjacent to a hood.

### BACKGROUND OF THE INVENTION

Business owners generally use a sign to attract customers and establish a presence in their community. An effective and informative sign improves the image of a business and increases sales by attracting potential customers passing by the signage every day.

Indoor and outdoor video displays and message centers, made of pixels consisting of clusters of light-emitting diode lamps (“LEDs”), are energy efficient and long lasting, weather resistant, instantly eye catching, and are a powerful advertising and promotional tool. An LED is a light source consisting of a light-emitting diode, a reflector, a plastic lens that focuses the emitted light into a conical beam, a pair of leads for connecting to a power supply, and a transparent or colored semi-transparent housing. An LED with two (2) leads is disclosed in U.S. Pat. No. 5,742,120 to Li-Yu Lin. Viewers of the display perceive pixels as single points of light. Pixels are combined into rows and columns in the display and switched on or off to form characters, words and images. Some pixels are switched partly on to produce partial levels of brightness. Pixels also contain light sources of differing colors. If the light sources can be switched on and off quickly, as is the case with LEDs, an impression of motion or scrolling text can be achieved in the display.

One problem with the use of LEDs or other small light sources is that a single LED may not be bright enough to be seen at a distance. Display providers have overcome this by clustering multiple LEDs together to make a single, large pixel, where all the LEDs in that pixel are switched on, off, or partly on together. Such clustered pixels may contain from two (2) to over one hundred (100) LEDs each.

Another problem with light-emitting displays is that direct exposure to sunlight or other incoming external light tends to reduce contrast and visibility due to glare from light reflected by the LEDs even when the LEDs in the display pixels are switched off. When glare is present, viewers of the display are less able to discern whether a particular LED is on or off and the viewer is left seeing only reflected light.

Light-emitting display providers have partially overcome this problem by including a single hood at the top of the cluster pixel enclosure to shade the LEDs from incoming external light, such as sunlight. A hood is a part that covers or shelters a piece of equipment. This style of single-hooded shading tends to provide shade to the upper row of LEDS on the front surface of the pixel, since they are nearest to the hood. However, the bottom row of LEDs is physically distant from the hood, so LEDs in the bottom row are not adequately shaded from direct sunlight or other incoming external light. In addition, a single-hooded pixel has a cumbersome elongated hood protruding from the upper surface of the pixel.

### SUMMARY OF THE INVENTION

The present invention provides a multi-hooded pixel for use in light-emitting displays, a light-emitting display that uses these pixels, and a method for manufacturing light-emitting displays and pixels by attaching light sources within an enclosure then attaching multiple hoods to the enclosure.

In one embodiment, a pixel has an enclosure with apertures for receiving light sources and a plurality of hoods adjacent to the apertures such that each aperture includes a separate hood. A hood is also referred to as a louver, cap or shield. The hoods protrude outwardly from the enclosure and shelter the apertures so as to limit incoming external light. In an outdoor sign display embodiment, the hoods are placed above or otherwise adjacent to the apertures to reduce glare caused by sunlight or other incoming external light. Further embodiments have more or less hoods than LEDs, so that some individual hoods shelter multiple LEDs, or so that multiple hoods shelter some individual LEDs.

In another embodiment, the pixel enclosure is vertically angled downwardly. When the pixel is mounted on a display panel, the pixel is tilted, thereby directing the emitted light downwardly. For signs placed above eye level, a downwardly directed pixel projects more light to the intended audience. In yet another embodiment, the pixel enclosures are also angled horizontally so that the emitted light is directed to the right or left, thus allowing for different viewing angles.

In still another embodiment, the pixels contain light sources in the apertures. One suitable light source is a light-emitting diode lamp (“LED”). Other suitable light sources include incandescent lamps, fluorescent lamps, Xenon lamps, and fiber-optic light pipes. In a single-color pixel embodiment, the light sources in a pixel are all powered on, off, or partly on together, so as to always produce light of a single color. In a multi-color pixel embodiment, light sources of three (3) primary colors are mixed in a single pixel. The light sources are grouped into three (3) sets, where all light sources in a set are of the same primary color, and the sets of light sources are turned on, off, or partly on, so as to be capable of varying the colors produced by a single pixel.

In a further embodiment, the pixel has three (3) sections. The first section contains a plurality of light sources and a plurality of hoods, where each of the light sources is directed outwardly and each of the hoods is positioned adjacent to each light source. The second section has a plurality of apertures so that each light source extends out of the apertures. The third section is adapted such that an electrical power source can be connected to the light sources.

In yet another embodiment, a light-emitting display panel contains a power source and at least one display module, where each display module contains a plurality of pixels arranged in a matrix. These pixels contain a plurality of light sources, such as LEDs, and a plurality of hoods to shelter the light sources from sunlight or other incoming external light. The hoods are adjacent to the light sources such that a hood shelters each light source.

In another embodiment, the light-emitting display panel also includes driver boards to provide power and control to the pixels, a master controller, a DC power supply, and communications equipment to facilitate programming the display.

In still another embodiment, a method for manufacturing light-emitting displays is provided. Light sources are attached to an enclosure, and hoods are affixed to the enclosure to shelter the light sources from sunlight or incoming external light.

In yet another embodiment, a method for manufacturing pixels is disclosed. The method includes affixing a plurality of hoods to an enclosure. The method further includes attaching a plurality of light sources within the enclosure such that each of the plurality of hoods is affixed to the enclosure adjacent to at least one of the plurality of light sources. Each hood is affixed to the enclosure such that each hood shelters a portion of at least one of the plurality of light sources so as to limit incoming external light.

### BRIEF DESCRIPTION OF THE DRAWINGS

FIG. 1 is a front perspective view illustrating a pixel having six hoods and six LEDs;

FIG. 2 is a rear perspective view of the pixel of FIG. 1;

FIG. 3 is a front elevational view illustrating the pixel of FIG. 1;

FIG. 4 is a side elevational view illustrating the pixel of FIG. 1;

FIG. 5 is a diagram illustrating a pixel angled downwardly with increased viewable angle area;

FIG. 6 is a top plan view illustrating the pixel of FIG. 1;

FIG. 7 is a bottom view illustrating the pixel of FIG. 1;

FIG. 8 is a rear perspective view of a pixel that is mounted with two leads;

FIG. 9 is a front elevational view illustrating a pixel with no light sources;

FIG. 10 is a front elevational view illustrating an arched hood;

FIG. 11 is a front elevational view illustrating a flat hood;

FIG. 12 is a front elevational view illustrating a pointed hood;

FIG. 13 is a front elevational view illustrating a semi-rectangular hood;

FIG. 14 is a top perspective view illustrating a hood with tabs;

FIG. 15 is a front perspective view illustrating a display panel containing eighty columns and sixteen rows of pixels, with one display module opened;

FIG. 16 is a right elevational view illustrating the display panel of FIG. 15, with all display modules closed;

FIG. 17 is a rear perspective view illustrating the display panel of FIG. 15;

FIG. 18 is a schematic diagram illustrating the use of a loader device for communicating display-programming data to a display panel;

FIG. 19 is a schematic diagram illustrating peripheral devices used to power and control a light-emitting display panel; and

FIG. 20 is a front perspective view illustrating a pixel as it is mounted into a display module.

### DETAILED DESCRIPTION OF THE INVENTION

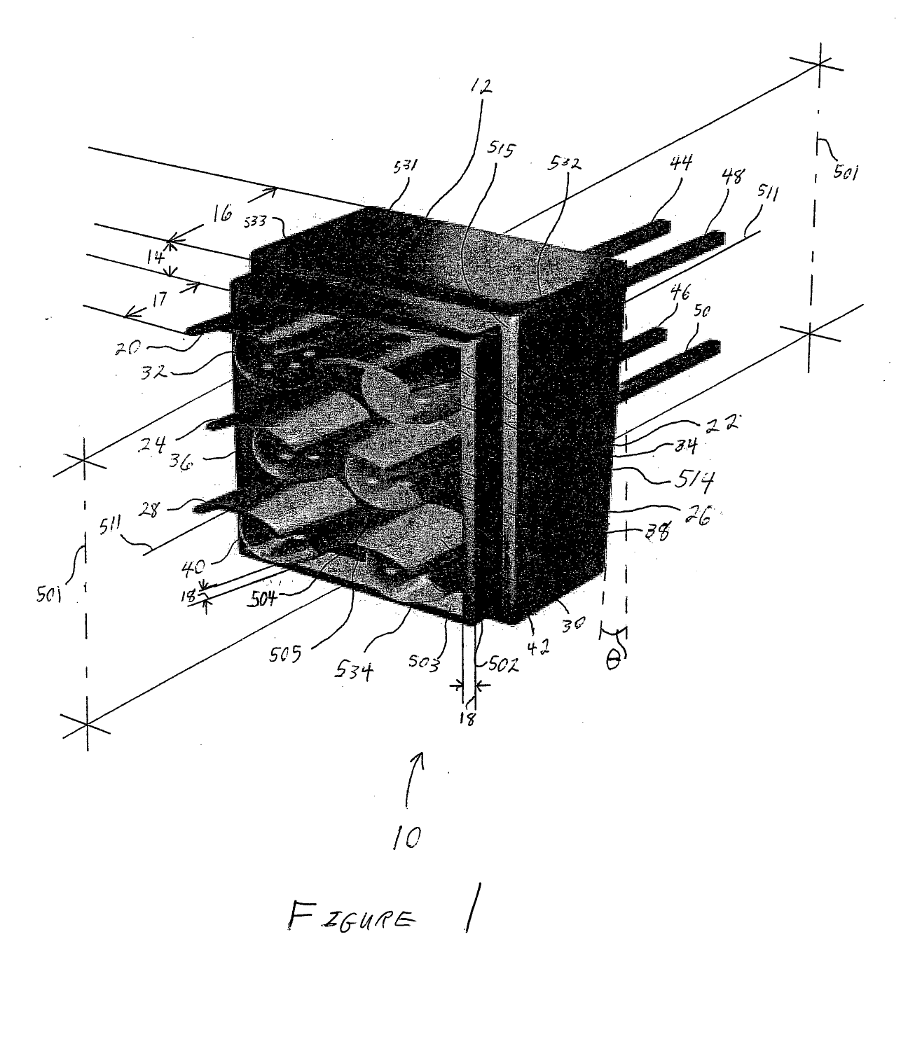

FIG. 1 depicts a front perspective view of a pixel 10. Pixel 10 has an enclosure 12, which includes three sections 14, 16 and 17, a central axis 511, and a vertical plane of symmetry 501. All three sections are molded to form a single piece around central axis 511 and vertical plane of symmetry 501. In an alternative embodiment, the three sections are fabricated from a substantially rigid material, and then assembled together to form single enclosure 12. In this embodiment, the perimeters of sections 14, 16 and 17 are substantially square, thereby forming a square pixel 10.

First section 17 of enclosure 12 includes six hoods 20, 22, 24, 26, 28 and 30 and six light-emitting diode lamps (“LEDs”) 32, 34, 36, 38, 40 and 42, arranged around central axis 511 and vertical plane of symmetry 501. All of the LEDs 32, 34, 36, 38, 40 and 42 are mounted at the same depth as each other, and each LED is directed outwardly and parallel to central axis 511 so as to emit light away from enclosure 12. Each of the hoods is positioned above and adjacent to each of the LEDs so as to project outwardly and shelter the LEDs by limiting incoming external light.

A hood is also sometimes referred to as a louver, cap or shield. Each hood 20, 22, 24, 26, 28 and 30 is a piece of material shaped and positioned to control the radiation of light. In the embodiment of FIG. 1, hoods 20, 22, 24, 26, 28 and 30 are arched so as to be convex underneath and concave on top. The material may be plastic, metal, or any other material capable of being formed into a small wedge or strip. The finish of the surface of hoods may be dark matte or any other finish. Hoods 20, 22, 24, 26, 28 and 30 may be attached to enclosure 12 in a separate manufacturing step or hoods 20, 22, 24, 26, 28 and 30 and enclosure 12 may be manufactured as a single molded piece.

Second section 14 of enclosure 12 includes an outer surface 502, an inner surface 503, and an enclosure face 504, where both outer surface 502 and inner surface 503 are joined to enclosure face 504 at substantially right angles. The sides of outer surface 502 and inner surface 503 are substantially parallel to vertical plane of symmetry 501. The upper and lower portions of outer surface 502 and inner surface 503 are perpendicular to vertical plane of symmetry 501. Outer surface 502 and inner surface 503 form a thickness, which defines lip 18. Lip 18 runs around the perimeter of second section 14 so as to define a cavity 505. Enclosure face 504 is positioned so as to be seated inside cavity 505. First section 17 extends out from cavity 505. Enclosure face 504 is substantially perpendicular to central axis 511, and is bisected by vertical plane of symmetry 501. Enclosure face 504 has apertures (not shown) adapted to position each of the LEDs 32, 34, 36, 38, 40 and 42 so that each LED extends out of an aperture. Lip 18 surrounds enclosure face 504, protects the apertures, and thereby protects the LEDs at the point where the LEDs extend out of the apertures. Enclosure face 504 also has a surface on which hoods 20, 22, 24, 26, 28 and 30 are attached. Each of the hoods and LEDs extends out of enclosure face 504 and through cavity 505 to form first section 17.

Second section 14 of enclosure 12 extends out of third section 16 of enclosure 12 and shares common central axis 511. The perimeter of third section 16 is larger than the perimeter of second section 14. A front surface 515 is attached at the outside edges to third section 16 and at the inside edges to second section 14, so that front surface 515 encircles lip 18 to form a step-down in perimeter and area.

Third section 16 of enclosure 12 includes an upper surface 531, two (2) side surfaces 532 and 533, a lower surface 534, front surface 515, and a rear wall 514. Upper surface 531 joins to side surfaces 532 and 533 at substantially right angles, and side surfaces 532 and 533 join to lower surface 534 at substantially right angles. Upper surface 531 and lower surface 534 are substantially perpendicular to vertical plane of symmetry 501. Side surface 532 and side surface 533 are substantially parallel to vertical plane of symmetry 501. Upper surface 531, side surface 532, side surface 533 and lower surface 534 are all joined to front surface 515 at substantially right angles. Front surface 515 is substantially perpendicular to central axis 511, and is bisected by vertical plane of symmetry 501.

Upper surface 531 is substantially rectangular in shape. Lower surface 534 is substantially rectangular in shape, and has the same length but a smaller width than upper surface 531. Side surfaces 532 and 533 have a trapezoidal shape. Upper surface 531, side surfaces 532 and 533, and lower surface 534 have rear edges forming rear wall 514. The upper portion of rear wall 514 is formed by the rear edge of upper surface 531, is substantially perpendicular to vertical plane of symmetry 501, and is bisected by vertical plane of symmetry 501. The lower portion of rear wall 514 is formed by the rear edge of lower surface 534, is also substantially perpendicular to vertical plane of symmetry 501, and is also bisected by vertical plane of symmetry 501. The side portions of rear wall 514 are formed by the rear edges of side surfaces 532 and 533, are substantially parallel to vertical plane of symmetry 501, and are sloped at the rear edges by an angle theta from a direction parallel to vertical plane of symmetry 501.

Alternative embodiments contain other quantities of LEDs and hoods, with at least two (2) hoods. Further embodiments have more or less hoods than LEDs, so that some individual hoods shelter multiple LEDs, or so that multiple hoods shelter some individual LEDs. Yet other embodiments are non-rectangular or non-symmetrical, where the perimeters of sections 14, 16, and 17 form rectangles, trapezoids, circles, ovals, triangles, parallelograms, or other closed figures. Still other embodiments contain different configurations of apertures. Enclosure 12 and surfaces 14, 16 and 17 may be made of plastic, metal, or any other material capable of receiving and holding LEDs or other light sources. In yet further embodiments, lights sources other than LEDs are used. In addition to LEDs, suitable light sources include, but are not limited to, incandescent lamps, fluorescent lamps, Xenon lamps, and fiber-optic light pipes.

Each LED in pixel 10 may be of the same color, or LEDs of different colors may be mixed together in a single pixel 10. Each LED is encapsulated within each aperture in first section 17 using an adhesive, such as an epoxy resin compound. One advantage of using an individual enclosure for each pixel, when compared to direct mounting of all pixels on a large substrate, is that maintenance of the display can be more easily accomplished since service on a single pixel requires removal and replacement of only that pixel.

In this embodiment of enclosure 12, the frontal surface area of second section 14 is smaller than the rear surface area of third section 16. When LEDs in second section 14 are held in place by an epoxy resin compound or other adhesive, this reduction can lessen the amount of adhesive applied to second section 14 while maintaining the rear dimensions to facilitate handling and spacing of enclosure 12 during manufacture and installation. Enclosure 12 also contains lip 18 around the front perimeter of second section 14. When LEDs in second section 14 are held in place by an epoxy resin or other adhesive, lip 18 helps reduce spillage of the adhesive during manufacture.

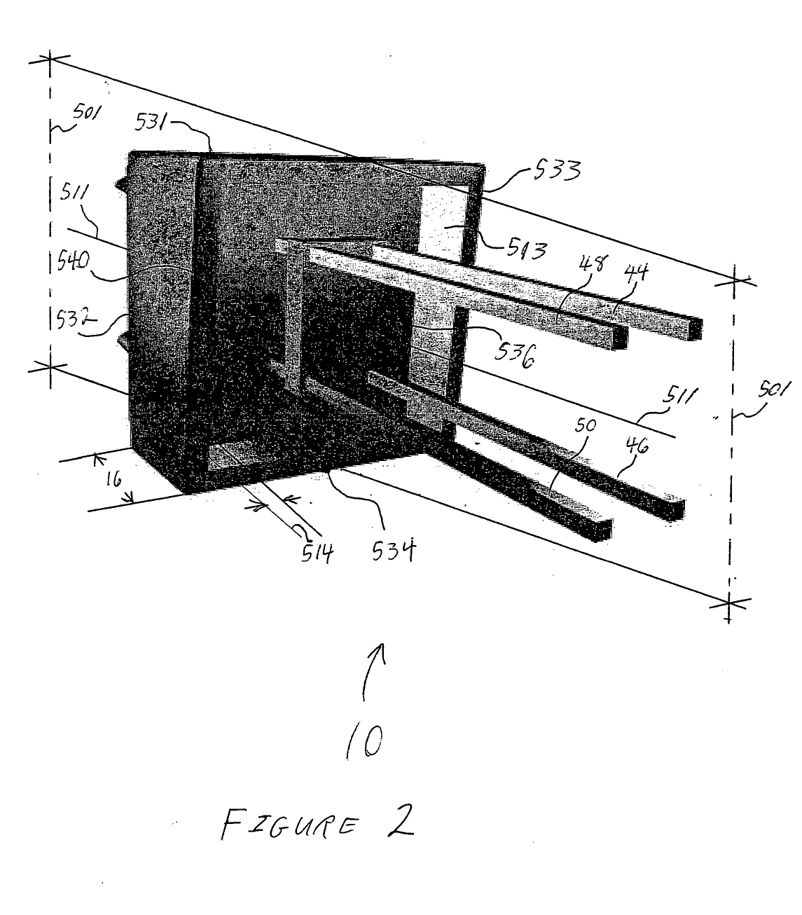

FIG. 2 depicts a rear perspective view of pixel 10. A rear inner surface 513 has four sides. The left and right sides of rear inner surface 513 are substantially parallel to vertical plane of symmetry 501. The top and bottom sides of rear inner surface 513 are substantially perpendicular to vertical plane of symmetry 501. Rear inner surface 513 forms four thicknesses with the four outer surfaces 531, 532, 533 and 534 of third section 16 of enclosure 12 to form real wall 514. The upper side of rear inner surface 513 forms a thickness with upper surface 531. The sides of rear inner surface 513 form thicknesses with the two side surfaces 532 and 533. The lower side of rear inner surface 513 forms a thickness with lower surface 534. Rear wall 514 runs around the perimeter of the back of third section 16 of enclosure 12 and defines a rear cavity 536.

A printed wiring board (“PWB”) 540 is seated in rear cavity 536. In a multi-color embodiment of pixel 10, PWB 540 is connected to four leads 44, 46, 48 and 50. The LEDs 32, 34, 36, 38, 40 and 42 (not shown) are mounted on the front surface of PWB 540, and leads 44, 46, 48 and 50 are mounted on the rear surface of PWB 540 so as to be in electrical contact with the LEDs. During assembly, PWB 540 is inserted into rear cavity 536 through the rear of third section 16 so that each of the LEDs 32, 34, 36, 38, 40 and 42 fits into one (1) of the apertures (not shown). An epoxy resin or other adhesive is then added to cavity 505 (not shown) in the front of enclosure 12 to fix the LEDs in place. Other known manufacturing methods may be utilized to assemble pixel 10.

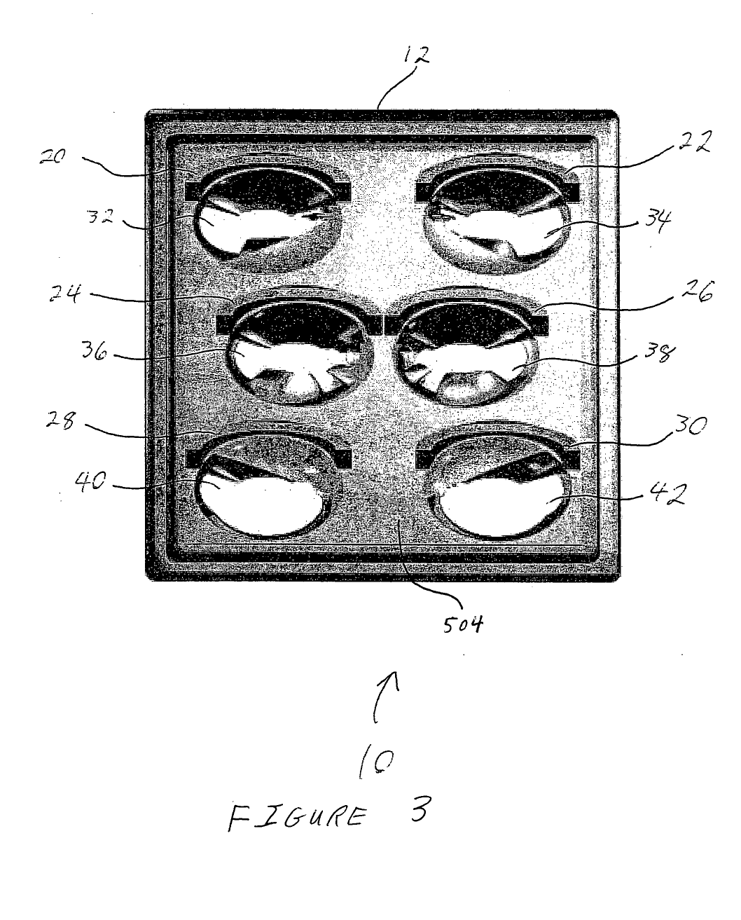

FIG. 3 depicts a front elevational view of the pixel 10. In this embodiment, the six (6) LEDs 32, 34, 36, 38, 40 and 42 and six (6) hoods 20, 22, 24, 26, 28 and 30 are configured in a pre-determined pattern, and the LEDs 32, 34, 36, 38, 40 and 42 are all positioned so as to extend through enclosure face 504 so as to be seated at the same depth as one another. The LEDs are all round or oval, having an axis of symmetry through the center of the LED. The hoods are adjacent to and follow the perimeter of the LEDS. Other arrangements and shapes of LEDs and hoods are suitable, as are differing quantities of LEDs and hoods per pixel.

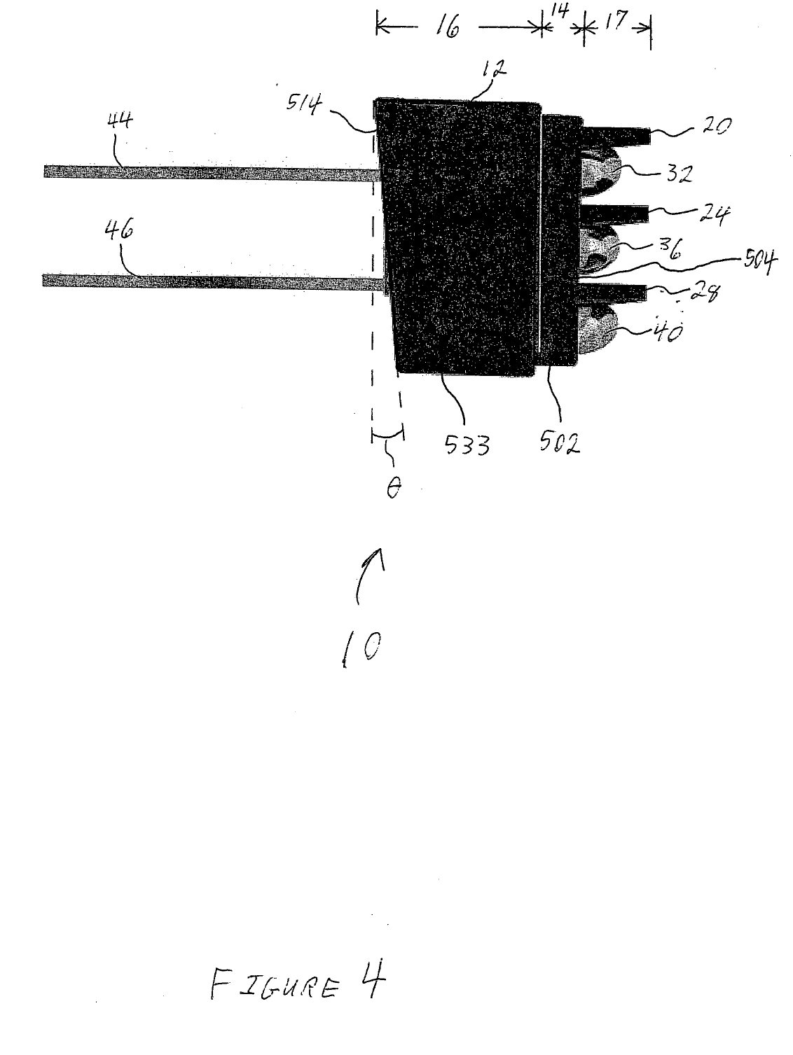

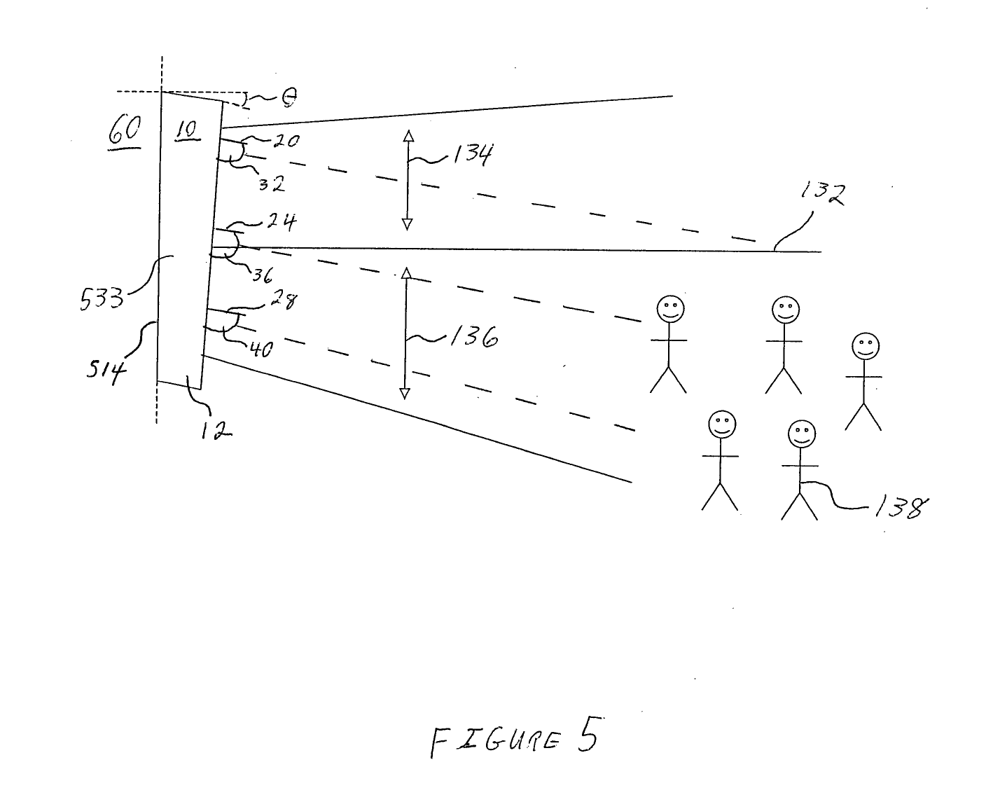

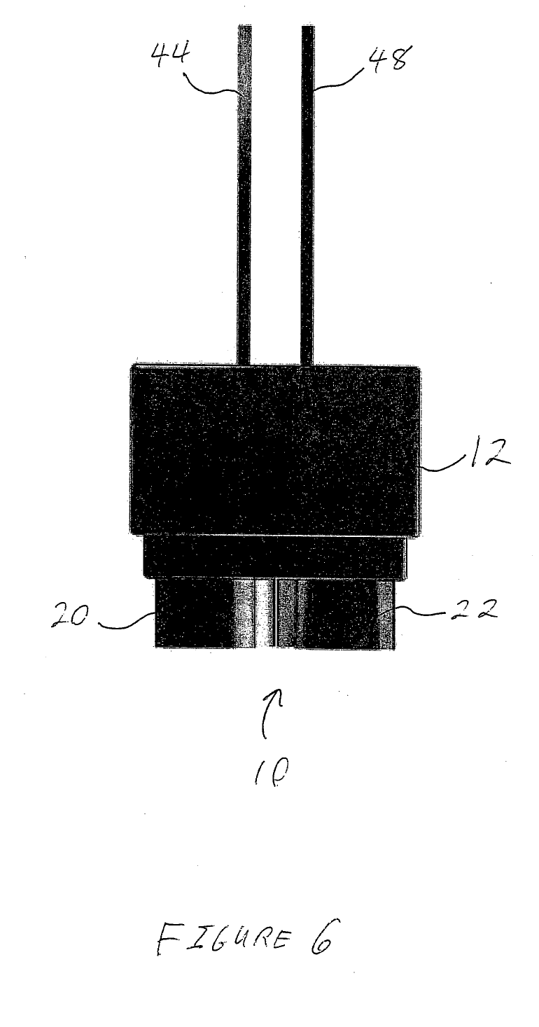

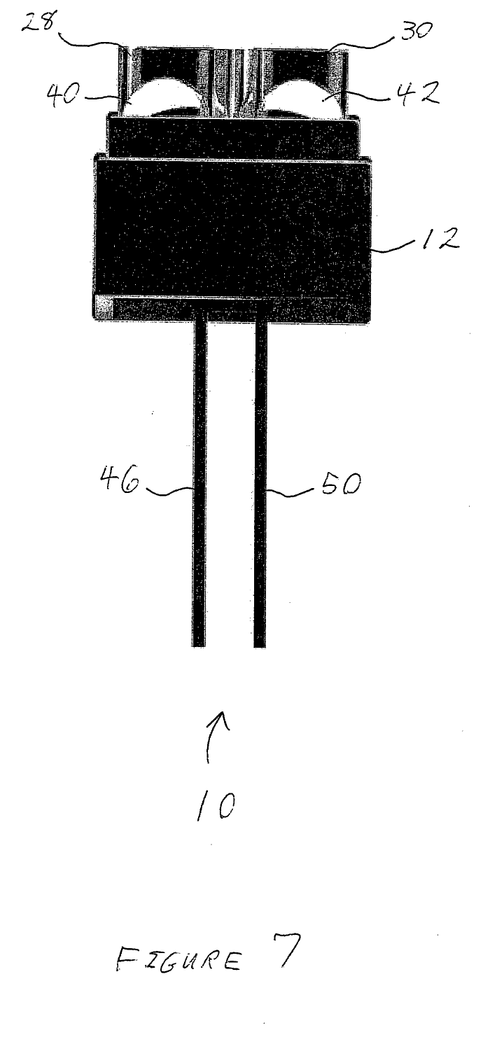

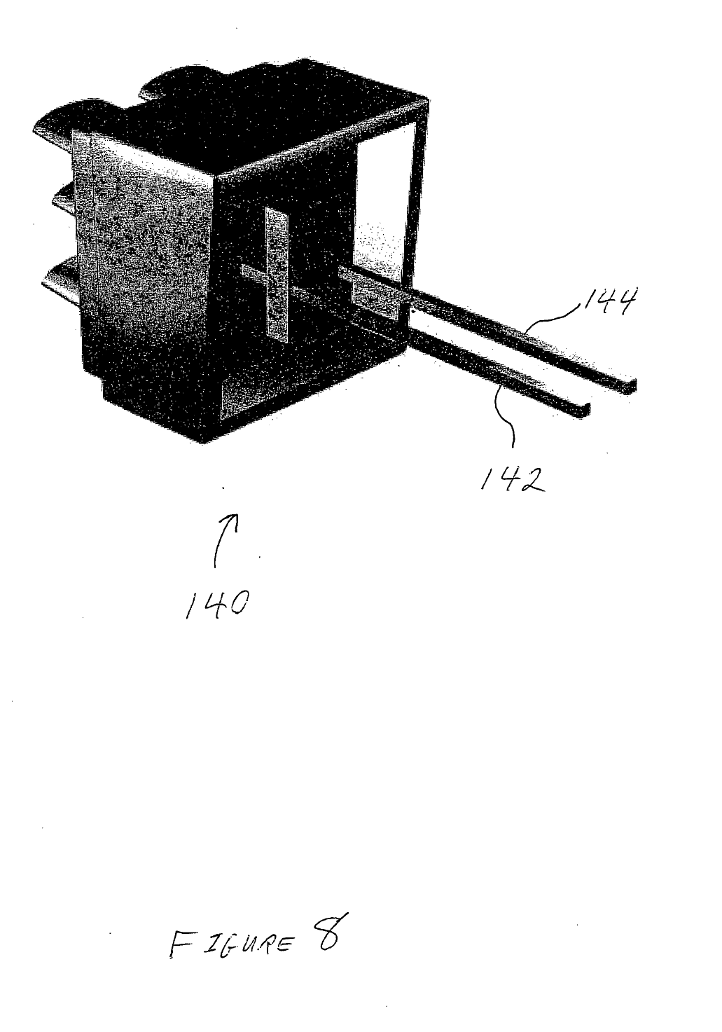

FIG. 4 depicts a side elevational view of pixel 10. Each hood 20, 22, 24, 26, 28 and 30 (hoods 22, 26, and 30 not shown) is attached to and protrudes outwardly from enclosure 12 to provide shade by blocking incoming external light from one (1) of LEDs 32, 34, 36, 38, 40 and 42 (LEDs 34, 38 and 42 not shown). As shown in FIG. 4, hood 20 is adjacent LED 32, so hood 20 thereby acts as a barrier to shelter LED 32 from incoming light, such as sunlight. Glare, incoming external light, and light emitted from adjacent or nearby pixels and LEDs are reduced when LED 32 is sheltered by hood 20. Ambient light degradation is reduced, and contrast between pixel 10 in its on and off states is thereby improved.

FIG. 4 also illustrates the angle of rear wall 514 of enclosure 12 relative to the rest of pixel 10. When rear wall 514 in third section 16 of enclosure 12 is vertical, as it would be when mounted flat against an upright display panel (not shown), the orientation of enclosure face 504 of enclosure 12 is at an angle theta to the front surface of the display panel (not shown). Pixel 10 is thus tilted downwardly. In one embodiment, pixel 10 is angled six (6) degrees downwardly. This may be accomplished by manufacturing enclosure 12 with an angled rear wall 514, or by adding a wedge to the rear wall 514 in a separate step. Other angles theta would also be suitable, so as to accommodate differing requirements for the viewing angle.

FIG. 5 is a side view of pixel 10 viewed from side surface 533, illustrating the effect of tilting pixel 10 at an angle theta downward. Horizontal line 132 is perpendicular to the surface of a display panel 60. Light emitted above horizontal line 132 is projected into upper portion 134, and light emitted below horizontal line 132 is projected into lower portion 136. Most signs are positioned at or above the eye level of the intended viewing audience 138. Light projected into upper portion 134 is wasted, because the light shines above the viewing angle of the intended viewing audience 138. The intended viewing audience 138 can not see light in upper portion 134. Light projected into lower portion 136 is more likely to be seen, since that is where the intended viewing audience 138 is located.

In the embodiment of FIG. 5, rear wall 514 of enclosure 12 is mounted vertically, so pixel 10 is effectively tilted downward relative to horizontal line 132. Some of the light emitted by LEDs 32, 34, 36, 38, 40 and 42 (LEDs 34, 38 and 42 not shown) in pixel 10 is projected into upper portion 134 above horizontal line 132, and some light emitted by the LEDs in pixel 10 is projected into lower portion 136 below horizontal line 132. By tilting the front surface of pixel 10 downwardly the LEDs are also tilted downwardly, so more light is projected into lower portion 136, and more viewers in intended viewing audience 138 can see the messages or images.

In another embodiment, rear wall 514 of enclosure 12 is also angled to the left side or right side of horizontal line 132. In addition to any downward tilt, pixel 10 is thus tilted to the left or right. This sideways tilt allows for different viewing angles without the need for structural changes to display panel 60. Since pixels 10 can be tilted vertically, horizontally, or both, depending on the location of intended viewing audience 138, sign manufacturing costs can be reduced and visibility can be improved for existing signs that were constructed in less than optimal locations.

FIG. 6 depicts a top plan view of pixel 10. Hoods 20 and 22 extend out past LEDs 32 and 34 (not shown) so as to inhibit or block light from incoming external light.

FIG. 7 depicts a bottom plan view of pixel 10. Hoods 28 and 30 extend out past LEDs 40 and 42 so as to inhibit or block incoming external light.

FIG. 8 depicts a rear perspective view of a single-color pixel 140 having two (2) leads to mount pixel 140 on a display panel (not shown). The LEDs in this embodiment may be all of the same color or may be of differing colors. The leads are made of electrically conductive material. Each LED has two (2) light-source leads, one positive and one negative. A first lead 142 is electrically connected to the positive light-source leads for each of the LEDs in single-color pixel 140, and a second lead 144 is electrically connected to the negative light-source leads of each of the LEDs. The two (2) leads in pixel 140 complete an electrical circuit when connected to driver board 112 (not shown) or another electrical power source.

In this embodiment of a single-color pixel 140, all LEDs will be switched on, switched off, or switched partly on together, so as to effectively produce a single point of emitted light at varying levels of brightness. If LEDs are all the same color, the light emitted from pixel 140 will be of that color. If some of the LEDs are of differing colors, the light emitted from pixel 140 will appear to viewers to be a mixture of the colors of the LEDs.

As discussed earlier, FIG. 2 shows a multi-color pixel 10 adapted to be mounted on a display panel (not shown) using four leads 44, 46, 48, and 50. The LEDs in a multi-color pixel embodiment are selected from a set of three (3) primary colors, such as red, green, and blue. At least one (1) LED is selected from each of the set of primary colors. Leads 44, 46, 48 and 50 are made of electrically conductive material. First lead 44 is electrically connected to the positive light-source leads for all of the LEDs in pixel 10 of the first color, second lead 46 is electrically connected to the positive light-source leads for all LEDs of the second color, and third lead 48 is electrically connected to the positive light-source leads for all LEDs of the third color. Fourth lead 50 is electrically connected to the negative light-source leads of each of the LEDs. When fourth lead 50 is connected to a power source, each of leads 44, 46 and 48 completes a separate electrical circuit when also connected to the power source.

In the multi-color embodiment of pixel 10 of FIG. 2, each of the LEDs of the same color in pixel 10 is switched on, switched off, or switched partly on together. For example, if the third primary color is blue, all the blue LEDs are switched on or off together, since the positive leads of all the blue LEDs are connected to a single lead. The light emitted from pixel 10 will appear to viewers to be a mixture of the colors of the LEDs. Since each of the three (3) primary colors can be independently controlled, the light emitted from pixel 10 can be adjusted to produce a variety of colors.

In an alternative embodiment, cyan, magenta, and yellow are used as primary colors instead of red, green, and blue. In yet another embodiment, leads 44, 46 and 48 are connected to the negative light-source leads of the appropriate LEDs, and lead 50 is connected to all the positive light-source leads.

In a further embodiment, the leads in pixel 10 and pixel 140 consist of any material capable of conducting electricity, such as copper or steel wire, and pixel 10 and pixel 140 are attached to a display panel by other means, such as a screw, tab, or clip. In yet another embodiment, one (1) or more of the electrically conductive leads consists of a conductive structure, such as an electrically conductive screw, adapted to firmly attach pixel 10 and pixel 140 to a display panel (not shown). In still other embodiments, light sources other than LEDs are used, so long as the light sources have one (1) positive and one (1) negative light-source lead.

FIG. 9 depicts pixel 10 with enclosure face 504 of enclosure 12. Enclosure face 504 has apertures 150, 152, 154, 156, 158 and 160 adapted to receive and position light sources. As shown in FIG. 9, no light sources are positioned in enclosure face 504. LEDs are one suitable light source; other suitable light sources include, but are not limited to, incandescent lamps, fluorescent lamps, Xenon lamps, and fiber-optic light pipes. The presence of individual hoods 20, 22, 24, 26, 28 and 30 reduces glare from incoming external light and will improve contrast when light sources are positioned in the apertures. In another embodiment, hoods are elongated or otherwise shaped to shelter multiple apertures.

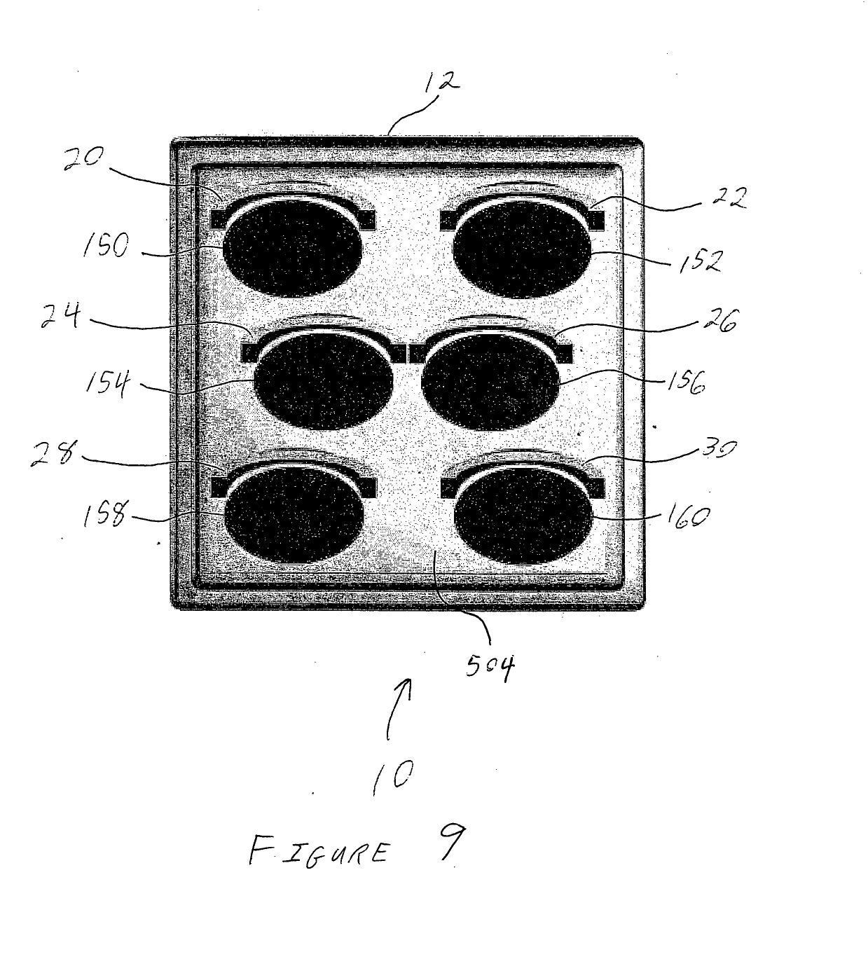

FIG. 10 depicts LED 32 and arched hood 20. Hood 20 extends laterally to the left of LED 32 and the same distance to the right. Hood 20 also descends vertically at least partly around the sides of LED 32 so as to block or limit light from the top and sides of LED 32. When pixel 10 is mounted horizontally on the front surface of an upright display panel (not shown), the proximity of hood 20 to LED 32 causes hood 20 to block LED 32 from light incoming from any external light source positioned above or nearly above the display.

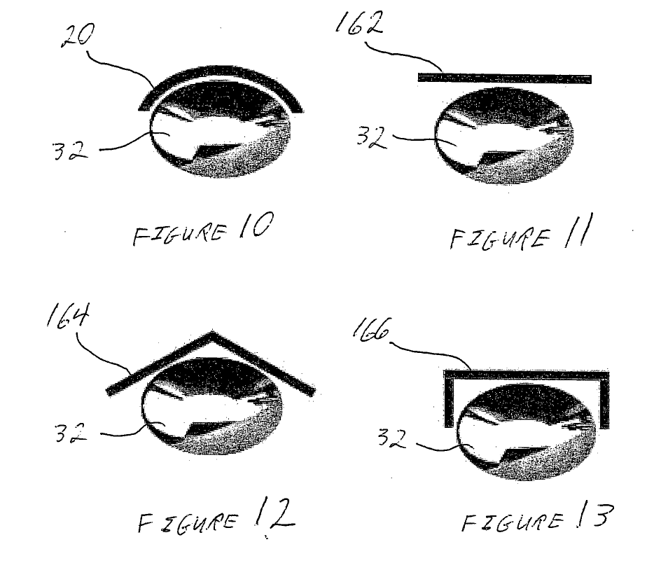

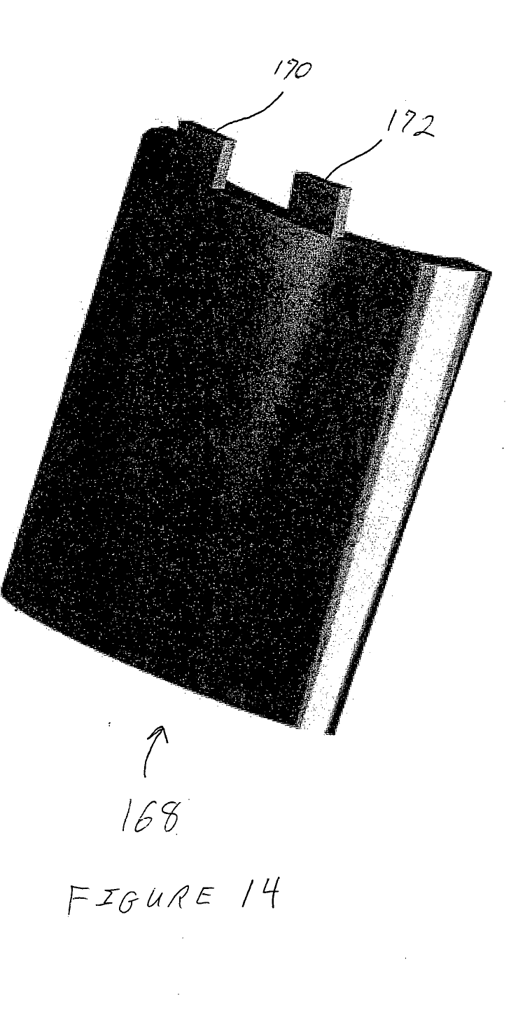

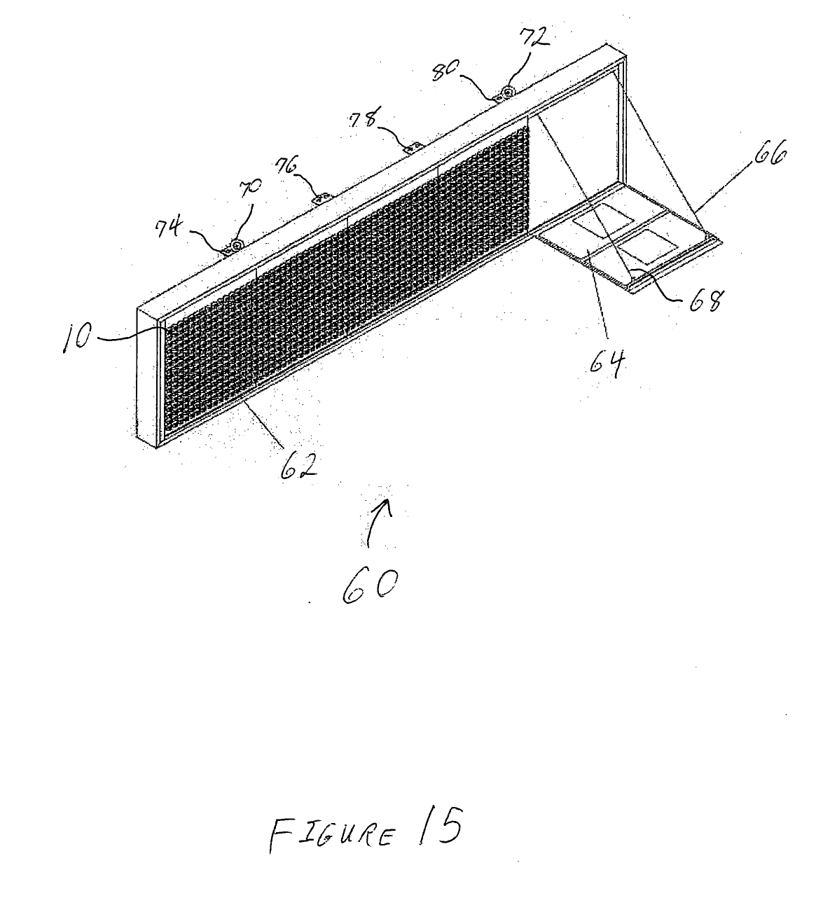

Hood 20 is arched to conform to the round shape of the top of an LED, while leaving adequate space between adjacent LEDs for manufacturing and for radiation of light. Due to the bottom surface area of hood 20 being arched, hood 20 can be put in direct contact or very close to LED 32, reducing glare and blocking incoming external light. Since hood 20 is shaped in an arch, less space between LEDs is occupied by hood 20 compared to a flat hood, and the light emitted from other LEDs in pixel 10 is not undesirably reduced. Since the lower sides of LED 32 are not covered by hood 20, this embodiment results in a high lateral viewing angle. FIGS. 11, 12 and 13 present alternative embodiments for the shape of a hood. FIG. 11 illustrates a flat hood 162 directly above LED 32. Since the sides of LED 132 are completely unblocked, this embodiment results in a high lateral viewing angle. FIG. 12 illustrates a pointed hood 164. This embodiment allows for greater blocking of incoming external light over flat hood 162 (shown in FIG. 11). FIG. 13 illustrates a semi-rectangular hood 166. This embodiment allows for even greater blocking of light over pointed hood 164 (shown in FIG. 12). Arched hood 20 (shown in FIG. 10), flat hood 162, pointed hood 164, and semi-rectangular hood 166 all provide different light blocking characteristics.

FIG. 14 depicts, in another embodiment, an arched hood 168 similar to that of hood 20 in FIG. 10 but with tabs 170 and 172 for inserting into corresponding notches in enclosure 12 (not shown). This approach retains the benefit of arched hood 20 of FIG. 10, and also provides flexibility by allowing manufacturing of hood 168 first and then attaching hood 168 to enclosure 12 in second step.

Other embodiments provide hoods of differing shapes and sizes that protrude out from enclosure 12 in varying lengths, or extend either more or less around or down the sides of the LEDs. The hoods may have rounded, flat, angled or shaped ends. In addition, the hoods may include tabs, holes, flanges, or transparent portions. When incoming external light is expected to come from the side, one side of a hood can extend farther down the corresponding side of the LED.

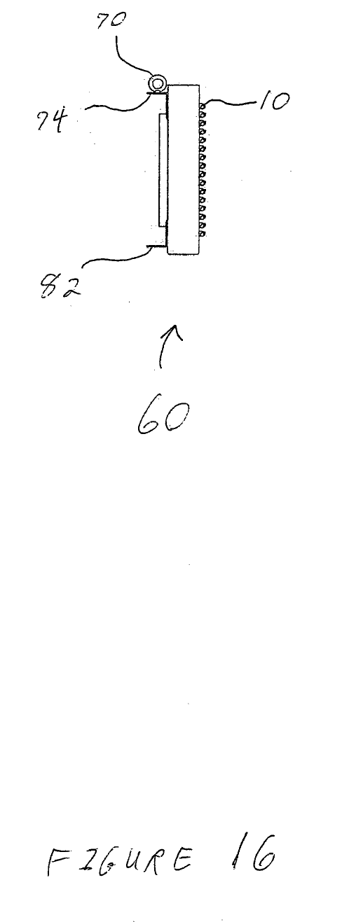

FIG. 15 depicts a front perspective view of display panel 60. Mounted in receptacles on the surface of a display area 62 in front of display panel 60 and facing out are a number of light-emitting pixels arranged in rows and columns, including pixel 10. One (1) or more pixels in this embodiment are arranged into a rectangular matrix of eighty (80) columns and sixteen (16) rows, where the last sixteen (16) columns of pixels are not shown. When pixels are arranged in a rectangular matrix, the horizontal distance between columns of pixels is often referred to as the horizontal dot pitch, and the vertical distance between rows of pixels is referred to as the vertical dot pitch. In the embodiment of FIG. 15, the horizontal dot pitch is equal to the vertical dot pitch. In another embodiment, the vertical dot pitch differs from the horizontal dot pitch to stretch or compress the height of the display. In yet a further embodiment, instead of being arranged in a rectangular matrix, the pixels are arranged to produce alphanumeric characters, figures, images, or punctuation.

Display area 62 in this embodiment consists of five display modules 64, each adapted to receive and position 256 pixels in sixteen (16) columns and sixteen (16) rows. The bottom of each display module 64 is rotatably attached to display panel 60, and two (2) steel wires 66 and 68 secure the top of each display module 64 to display panel 60. To facilitate maintenance access, the length of wire 66 and wire 68 are such as to allow each display module 64 to open and rest in a nearly horizontal position. Also included in this embodiment are two (2) holding rings 70 and 72, and four (4) mounting brackets 74, 76, 78 and 80.

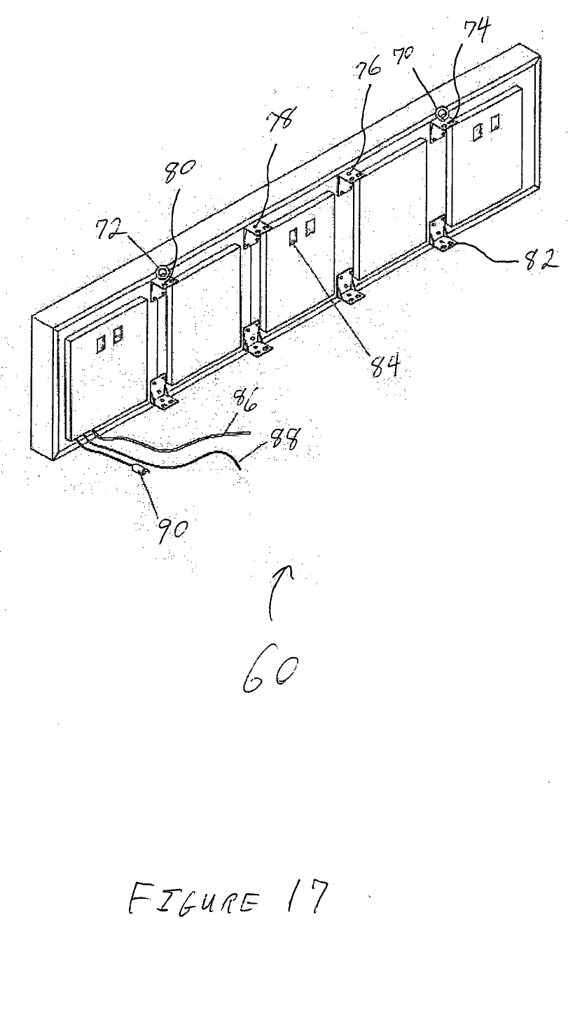

FIG. 16 depicts a side elevational view of display panel 60, including the rightmost column of pixels. Each pixel 10 in display panel 60 can be individually switched on, off, or partly on. When provided with power and control, the light produced by patterns of pixels 10 in display panel 60 can form characters, words and images. Text can be displayed either using a line matrix where rows of text are separated providing for one character size, or using full matrix where there is no separator between rows providing for more than one size of character. When pixels 10 are switched on and off quickly, a visual effect of motion or scrolling text is achieved.

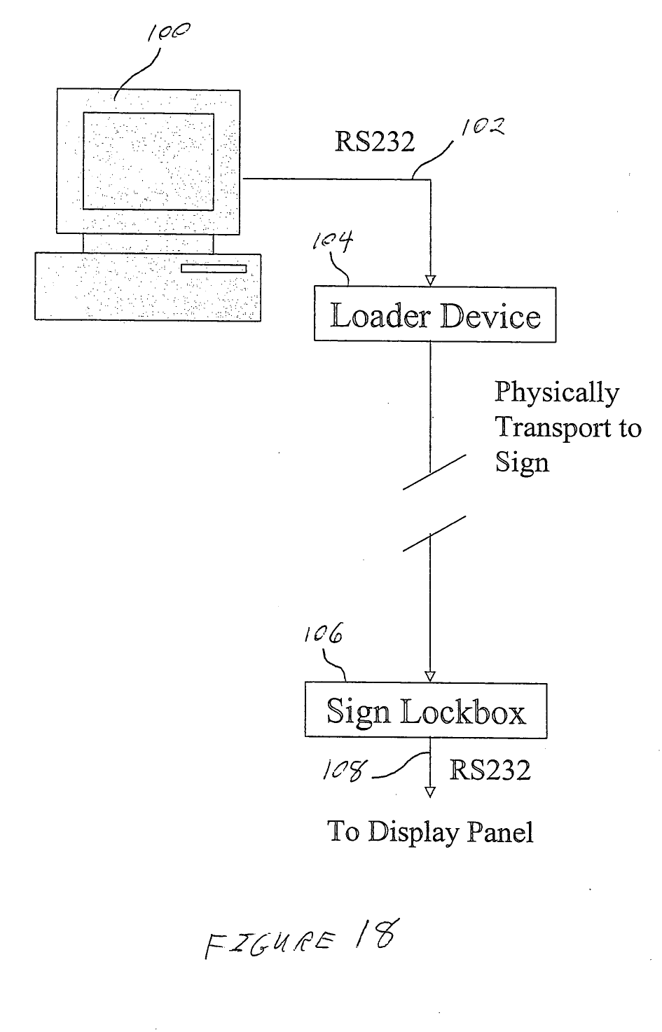

FIG. 17 depicts a rear perspective view of display panel 60. The rear wall of display panel 60 has portions defining ventilating windows 84 to help dissipate heat generated by pixels 10. In one embodiment, display panel 60 includes internal electric fans to further cool the pixels. Extending out from the rear of display panel 60 is a cable for electrical power 86, a cable for data and control 88, and a temperature sensor 90.

Display panel 60 may be fabricated from sheet metal or any other material capable of supporting the weight of the pixels and any control and power peripherals. Display panel 60 may be adapted to be used outdoors by encapsulation in a transparent, all-weather housing. In one embodiment, a polycarbonate face protects pixels 10 in display area 62 of FIG. 15 and aids in vandal resistance, although display brightness may be thereby reduced and heat accumulation may be increased.

Many embodiments comprehend common options for the colors to be produced by light-emitting displays, including but not limited to monochrome and multi-color. Embodiments comprehending other options, such as tri-color, would be obvious to one of ordinary skill in the art.

In a monochrome display embodiment, all pixels in display panel 60 use LEDs of the same color, such as amber or white.

In a multi-color embodiment, each pixel 10 in display panel 60 is capable of being individually controlled to display a variety of colors. Each pixel 10 uses at least one LED from each of a set of three (3) primary colors, such as red, green, and blue. In one embodiment, pixel 10 contains two (2) red LEDs, two (2) green LEDs, and two (2) blue LEDs. The light emitted by pixel 10 will appear to be a mixture of the light simultaneously emitted from the differently colored LEDs. All like colored LEDs in each pixel are grouped and controlled together so as to be capable of switching on, switching off, or switching partly on at the same time. By adjusting the relative intensities of light produced by the LEDs using each of the three (3) primary colors, a variety of color mixtures can be produced. For example, if the blue LEDs in a single pixel are all switched off and the red and green LEDs are fully switched on, the pixel will appear to produce yellow light, since equal mixtures of bright red and bright green appear yellow. This is called the RGB color model when red, green and blue are used as primary colors, and the CMY color model when cyan, magenta, and yellow are used as primary colors.

Multiple embodiments comprehend methods of communicating with display panel 60 in order to program the display. A personal computer (“PC”) runs software programs adapted to prepare text, images, and timing information, and to transmit this display-programming data to display panel 60. Suitable software programs such as WINEDT, WINEDL and MEDIAEDITOR are commercially available for this purpose, and other commonly available programs are easily built or adapted to prepare and transmit display-programming data using personal computers or other data processing devices.

Multiple embodiments of the display system represent different methods for communicating with display panel 60, including RS232, RS485, telephone modem, fiber-optic modem, radio frequency (RF) modem, and loader device. Still other embodiments include transmission via parallel cable, IEEE 488 (GPIB), IEEE 1394 (Firewire), IEEE 802.11 (wireless LAN), Ethernet, Internet, USB, flash memory card, PCMCIA card, hard disk drive, diskette, CD-ROM, tape and DVD. In an embodiment to improve security, the display-programming data is encrypted before transmission and decrypted upon reception. In an embodiment to improve reliability, display-programming data is verified before or after the data is transmitted.

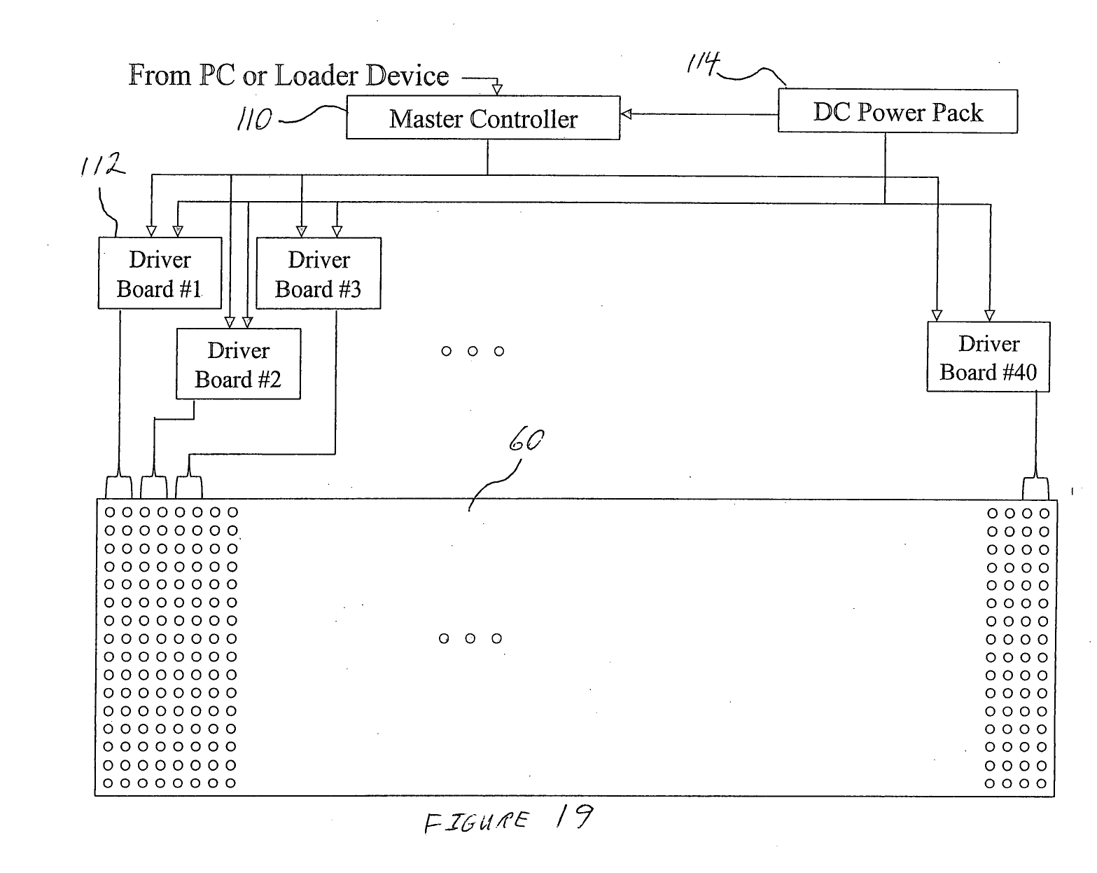

FIG. 18 depicts an embodiment to communicate using a loader device 104 and an operator. Loader devices contain batteries, a persistent memory, and means for inputting and outputting to the memory using a serial connection. Loader devices can easily be made, and existing hand held devices are easily adapted to function as loader devices. A PC 100 is connected via RS232 serial cable 102 to loader device 104. PC 100 transfers the display-programming data into loader device 104. An operator then physically transports loader device 104 to a sign lockbox 106. Sign lockbox 106 contains one end of an RS232 serial cable 108. Serial cable 108 is adapted to attach to loader device 104 on one end and is connected to display panel 60 on the other end. The operator opens sign lockbox 106, attaches loader device 104 to RS232 serial cable 108, and the display-programming data is transmitted. Once the transfer is complete, loader device 104 may be detached and its memory erased in preparation for the next transfer.

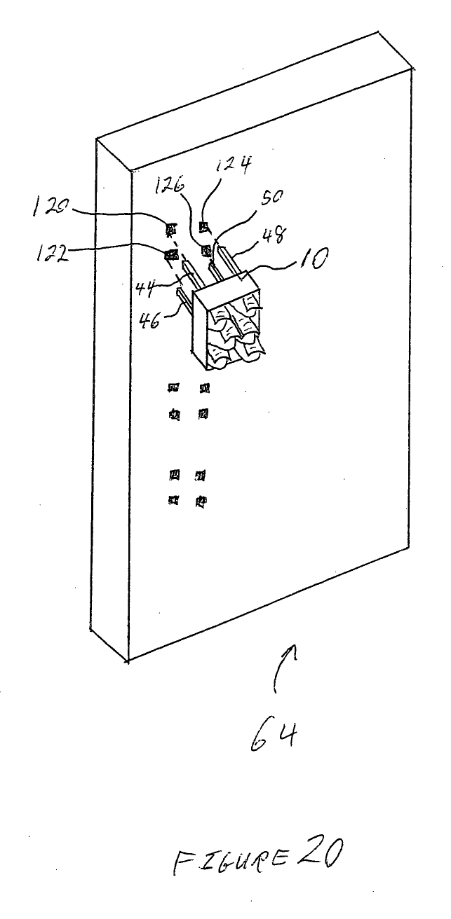

FIG. 19 depicts an embodiment where peripheral components provide the ability to operate display panel 60, including a master controller 110, a plurality of driver boards 112, and a DC power pack 114.

Master controller 110 includes persistent memory and a built-in real time clock. In one embodiment, master controller 10 provides both RS232 and RS485 communication interfaces to receive display-programming data as described in the communication embodiments. Master controller 110 stores or otherwise retains the display-programming data and controls each driver board 112. Master controller 110 is powered by DC power pack 114. Master controller 110 is capable of using an internal clock to produce an application for time or for time and date display. Master controller 110 determines the appropriate on or off setting for every pixel 10 in real time then sends control signals to each driver board 112. When a temperature sensor is attached, master controller 110 is capable of producing an application for temperature display.

Driver board 112 effectuates the turning on and off of some of pixels 10 on display panel 60. In the embodiment of FIG. 19, each driver board 112 provides power to up to two (2) columns of sixteen (16) pixels 10. Each driver board 112 receives commands from master controller 110. In the embodiment of FIG. 19, display panel 60 contains eighty (80) columns of sixteen (16) pixels, so forty (40) driver boards are required. In this embodiment, each driver board 112 receives control directly from single master controller 110. In another embodiment, only first driver board 112 is directly connected to master controller 110, and remaining driver boards 112 are connected in a daisy chain to previous driver board 112.

DC power pack 114 supplies electrical power at 9 VDC and up to 150 Watts to both master controller 110 and each driver board 112. This allows display panel 60 to be self-contained, and operate without intervention as long as the batteries last. In another embodiment, DC power pack 114 receives power from an external AC connection, solar cells, or any other electrical source. In yet other embodiments, other voltage or power levels are supplied to meet the requirements of master controller 110 and each driver board 112.

FIG. 20 depicts pixel 10 as it is mounted on display module 64. Display module 64 is one of five display modules contained in display panel 60. In this embodiment, four leads 44, 46, 48, and 50 are used to mount pixel 10 on display module 64. Display module 64 has four holes 120, 122, 124 and 126 corresponding to four leads 44, 46, 48 and 50 for a multi-colored pixel. Each lead fits into a single hole. Leads 44, 46, 48 and 50 conduct electrical power to pixel 10 from driver board 112 behind display module 64. Pixel 10 can be pressed in and removed by hand during maintenance, or pressed in by a machine during manufacture.

In one embodiment, a method for manufacturing light-emitting displays is provided. One embodiment consists of two (2) steps. First, a plurality of light sources is attached within an enclosure. Second, a plurality of hoods is affixed to the enclosure such that each hood protrudes outwardly from the enclosure. The ordering of the first and second steps may be reversed. This method helps manufacture pixels with individual enclosures, as in pixel 10 with enclosure 12. The method further helps manufacture displays having large substrates consisting of many light sources with no separate pixel enclosures.

In a further embodiment of the method, each hood is attached so as to be adjacent or above each of the light sources. In yet another embodiment, the hoods are attached so as to shelter the light sources from incoming external light.

In yet another embodiment, a method for manufacturing pixels is disclosed. The method includes affixing a plurality of hoods to an enclosure. The method further includes attaching a plurality of light sources within the enclosure such that each of the plurality of hoods is affixed to the enclosure adjacent to at least one of the plurality of light sources. Each hood is affixed to the enclosure such that each hood shelters a portion of at least one of the plurality of light sources so as to limit incoming external light.

While the invention has been described in terms of various specific embodiments, those skilled in the art will recognize that the invention can be practiced with modification within the spirit and scope of the claims.

1. A pixel comprising:
an enclosure having portions defining a plurality of apertures, where each of the plurality of apertures is adapted to receive a light source; and
a plurality of hoods, wherein each of the plurality of hoods is attached to the enclosure and wherein each of the plurality of hoods protrudes outwardly from the enclosure.

2. The pixel according to claim 1 wherein each of the plurality of hoods shelters a portion of at least one of the plurality of apertures so as to limit incoming external light.

3. The pixel according to claim 2 wherein each of the plurality of hoods is adjacent to at least one of the plurality of apertures.

4. The pixel according to claim 2 wherein each of the plurality of apertures is adjacent to at least one of the plurality of hoods.

5. The pixel according to claim 1 wherein the enclosure is vertically angled so that said pixel is tilted downwardly.

6. The pixel according to claim 1 wherein the enclosure is horizontally angled so said pixel is tilted sideways.

7. The pixel according to claim 1 further comprising a plurality of light sources positioned within the plurality of apertures.

8. The pixel according to claim 7 wherein each of the plurality of light sources is adapted to receive electrical power from an electrically conductive structure adapted for mounting and holding said pixel.

9. The pixel according to claim 8 wherein the color of each of the plurality of light sources is selected from one of a selection of three (3) colors, so that at least one of the plurality of light sources is of the first color, at least one of the plurality of light sources is of the second color, and at least one of the plurality of light sources is of the third color.

10. The pixel according to claim 8 wherein each of the plurality of light sources is selected from the group consisting of light-emitting diode lamps, incandescent lamps, fluorescent lamps, Xenon lamps, and fiber-optic light pipes.

11. A pixel having an enclosure, the enclosure comprising:
a first section having a plurality of light sources and a plurality of hoods, each of the plurality of light sources being directed outwardly, and each of the plurality of hoods being positioned adjacent to each of the plurality of light sources;
a second section having a surface defining a plurality of apertures adapted to receive the plurality of light sources such that each of the plurality of light sources extends out of the plurality of apertures; and
a third section adapted to connect to an electrical power source such that the electrical power source is in electrical contact with the plurality of light sources.

12. A light-emitting display, comprising:
a panel comprising at least one display module, wherein each display module has a plurality of receptacles;
at least one electrical power source, wherein each display module is electrically connected to at least one electrical power source; and
a plurality of pixels positioned within the plurality of receptacles, each of the plurality of pixels comprising:
an enclosure having a front surface defining a plurality of apertures, each of the plurality of apertures adapted to receive a light source;
a plurality of light sources affixed to each of the plurality of apertures; and
a plurality of hoods, each of the plurality of hoods being attached to the front surface of the enclosure, each of the plurality of hoods protruding outwardly from the front surface of the enclosure, each hood further positioned adjacent each of the plurality of light sources, and each hood further sheltering a portion of the light source so as to limit incoming external light.

13. The light-emitting display of claim 12, wherein each of the plurality of pixels is adapted to receive electrical power so as to be capable of being individually switched on and off.

14. The light-emitting display of claim 13, further comprising at least one driver board, wherein each of the plurality of pixels is electrically connected to one of the driver boards so that each of the plurality of pixels receives power from the driver board.

15. The light-emitting display of claim 14, further comprising at least one master controller board, wherein each of the driver boards is electrically connected to at least one master controller board so that each driver board receives control signals from at least one master controller board.

16. The light-emitting display of claim 14, further comprising at least one power source, wherein the power source is electrically connected so as to provide power to at least one of the driver boards.

17. The light-emitting display of claim 12, further comprising equipment for communicating display-programming information from a personal computer to said light-emitting display.

18. A light-emitting display comprising a plurality of light emitting devices operatively coupled within at least one receptacle, each of the plurality of light emitting devices being provided with at least one hood adapted to block light.

19. The light-emitting display of claim 18, wherein the at least one hood is coupled to the at least one receptacle over each of the plurality of light emitting devices.

20. The light-emitting display of claim 18, wherein the at least one receptacle includes at least one power connector.

21. The pixel according to claim 18 wherein each of the plurality of light emitting devices is selected from the group consisting of light-emitting diode lamps, incandescent lamps, fluorescent lamps, Xenon lamps, and fiber-optic light pipes.

22. The light-emitting display of claim 18, wherein the at least one receptacle is tilted relative to at least one support structure.

23. The light-emitting display of claim 22, wherein the at least one receptacle is tilted vertically relative to at least one support structure.

24. The light-emitting display of claim 22, wherein the at least one receptacle is tilted horizontally relative to at least one support structure.

25. The light-emitting display of claim 22, wherein the at least one receptacle is tilted vertically and horizontally relative to at least one support structure.

26. A light-emitting display comprising a plurality of light emitting devices operatively coupled within at least one receptacle, each of said plurality of light emitting devices being provided with at least one hood adapted to block light, said at least one receptacle being tilted relative to at least one support structure to improve visibility.

27. A method for manufacturing light-emitting displays comprising:
attaching a plurality of light sources within an enclosure; and
affixing a plurality of hoods to the enclosure such that each of the plurality of hoods protrudes outwardly from the enclosure.

28. The method according to claim 27 wherein each of the plurality of hoods is affixed to the enclosure adjacent to at least one of the plurality of light sources.

29. The method according to claim 27 wherein each of the plurality of hoods is affixed to the enclosure so as to shelter a portion of at least one of the plurality of light sources so as to limit incoming external light.

30. A method for manufacturing pixels comprising:
affixing a plurality of hoods to an enclosure; and
attaching a plurality of light sources within the enclosure such that each of the plurality of hoods is affixed to the enclosure adjacent to at least one of the plurality of light sources.

31. The method according to claim 30 wherein each of the plurality of hoods is affixed to the enclosure so as to shelter a portion of at least one of the plurality of light sources so as to limit incoming external light.

32. The method according to claim 30 wherein each of the plurality of hoods protrudes outwardly from the enclosure.
